(19) United States
(12) Patent Application Publication
(10) Pub. No.: US 2026/0289869 A1
(43) Pub. Date: Sep. 24, 2026

(54) IMAGE GENERATION METHOD AND APPARATUS, ELECTRONIC DEVICE, AND COMPUTER-READABLE STORAGE MEDIUM

(71) Applicant: TENCENT TECHNOLOGY (SHENZHEN) COMPANY LIMITED, Shenzhen (CN)

(72) Inventor: Yuxuan YAN, Shenzhen (CN)

(21) Appl. No.: 19/687,842

(22) Filed: May 26, 2026

Related U.S. Application Data
(63) Continuation of application No. PCT/CN2025/109825, filed on Jul. 22, 2025.

(30) Foreign Application Priority Data
Jul. 30, 2024 (CN) 202411051690.3

(51) Int. Cl. G06T 11/60

(52) U.S. Cl. CPC G06T 11/60

(57) ABSTRACT

An image generation method and includes: acquiring preset noise, and acquiring an initial object image and image description text of a preset object, the image description text describing a target attribute of the preset object; performing first encoding on the initial object image to obtain image encoding features; performing second encoding on the image description text to obtain text encoding features; and generating a target object image using a diffusion model based on the image encoding features, the text encoding features, and the preset noise, the target object image including the preset object corresponding to the target attribute.

### CROSS-REFERENCES TO RELATED APPLICATIONS

This application is a continuation of PCT Application No. PCT/CN2025/109825, filed on July 22, 2025, which claims priority to Chinese Patent Application No. 202411051690.3, filed on July 30, 2024, the entire contents of all of which are incorporated herein by reference.

### FIELD OF THE TECHNOLOGY

The present disclosure relates to the technical field of artificial intelligence, and in particular, to an image generation method and apparatus, an electronic device, a computer-readable storage medium, and a computer program product.

### BACKGROUND OF THE DISCLOSURE

With the development of artificial intelligence, image generation has become an important application field of artificial intelligence. When image generation is performed based on a diffusion model, image generation is controlled based on text descriptions, often resulting in low quality of the generated images.

### SUMMARY

Embodiments of the present disclosure provide an image generation method and apparatus, an electronic device, a computer-readable storage medium, and a computer program product, capable of improving an image generation effect.

Technical solutions of the embodiments of the present disclosure are implemented as follows.

The embodiments of the present disclosure provide an image generation method, which is applied to an electronic device and includes: acquiring preset noise, and acquiring an initial object image and image description text of a preset object, the image description text describing a target attribute of the preset object; performing first encoding on the initial object image to obtain image encoding features; performing second encoding on the image description text to obtain text encoding features; and generating a target object image using a diffusion model based on the image encoding features, the text encoding features, and the preset noise, the target object image including the preset object corresponding to the target attribute.

The embodiments of the present disclosure further provide an image generation apparatus, including: an acquisition module, configured to acquire preset noise, and acquire an initial object image and image description text of a preset object, the image description text describing a target attribute of the preset object; an encoding module, configured to perform first encoding on the initial object image to obtain image encoding features, and perform second encoding on the image description text to obtain text encoding features; and a generation module, configured to generate a target object image using a diffusion model based on the image encoding features, the text encoding features, and the preset noise, the target object image including the preset object corresponding to the target attribute.

The embodiments of the present disclosure further provide an electronic device, including: a memory, configured to store computer-executable instructions; and a processor, configured to implement, when executing the computer-executable instructions stored in the memory, the image generation method provided in the embodiments of the present disclosure.

The embodiments of the present disclosure further provide a non-transitory computer-readable storage medium, having computer-executable instructions or a computer program stored therein, and the computer-executable instructions or the computer program, when executed by a processor, implementing the image generation method provided in the embodiments of the present disclosure.

The embodiments of the present disclosure have the following beneficial effects.

The target attribute of the preset object is described through the image description text. First encoding is performed on the initial object image to obtain the image encoding features, and second encoding is performed on the image description text to obtain the text encoding features. The target object image is generated using the diffusion model based on the image encoding features, the text encoding features, and the preset noise. In this way, the image encoding features retain features of an image domain of the initial object image, thereby ensuring consistency between the generated target object image and the preset object in the initial object image. In addition, the text encoding features can guide, by describing the target attribute, the diffusion model to generate an image conforming to the description of the image description text. Therefore, the image generation process of the diffusion model is controlled through the cooperation of multimodal information such as the image encoding features and the text encoding features, so as to generate the target object image that conforms to the description of the image description text and ensures the authenticity, thereby improving the image generation effect for the object.

### BRIEF DESCRIPTION OF THE DRAWINGS

FIG. 1 is a schematic architectural diagram of an image generation system according to an embodiment of the present disclosure.

FIG. 2 is a schematic structural diagram of an electronic device according to an embodiment of the present disclosure.

FIG. 3A is a first schematic flowchart of an image generation method according to an embodiment of the present disclosure.

FIG. 3B is a second schematic flowchart of an image generation method according to an embodiment of the present disclosure.

FIG. 3C is a third schematic flowchart of an image generation method according to an embodiment of the present disclosure.

FIG. 3D is a fourth schematic flowchart of an image generation method according to an embodiment of the present disclosure.

FIG. 4 is a schematic diagram of an image generation architecture according to an embodiment of the present disclosure.

FIG. 5 is a schematic structural diagram of a U-shaped network (Unet) according to an embodiment of the present disclosure.

FIG. 6 is a schematic diagram of a processing procedure of a cross-attention processing layer according to an embodiment of the present disclosure.

FIG. 7 is a schematic diagram of a processing procedure of a self-attention processing layer according to an embodiment of the present disclosure.

FIG. 8 is a schematic diagram of training of an image generation model according to an embodiment of the present disclosure.

FIGS. 9A to 9D are schematic diagrams of application of an image generation method according to an embodiment of the present disclosure.

The foregoing "first" and "second" are merely used for distinguishing different solutions, and do not represent superiorities of the solutions or priorities in an implementation process.

### DESCRIPTION OF EMBODIMENTS

To make the objectives, technical solutions, and advantages of the present disclosure clearer, the present disclosure will be described in further detail below with reference to the accompanying drawings. The described embodiments are not to be considered as a limitation to the present disclosure. All other embodiments obtained by a person skilled in the art without inventive efforts shall fall within the protection scope of the present disclosure.

The term, involved in the following description, "some embodiments" describes subsets of all possible embodiments. However, "some embodiments" may be the same subset or different subsets of all the possible embodiments, and may be combined with each other without conflict.

The term, involved in the following description, "first/second/third" is merely intended to distinguish similar objects rather than describing specific orders. The "first/second/third" is interchangeable in proper circumstances to enable the embodiments of the present disclosure to be implemented in other orders than those illustrated or described herein.

In the embodiments of the present disclosure, the term "module" or "unit" refers to a computer program having a predetermined function or a part of the computer program, works together with other relevant parts to achieve a predetermined objective, and may be all or partially implemented through software, hardware (such as a processing circuit or a memory), or a combination thereof. Similarly, one processor (or a plurality of processors or memories) may be configured to implement one or more modules or units. In addition, each module or unit may be a part of an overall module or unit containing a function of the module or unit.

Unless otherwise defined, meanings of all technical and scientific terms used in the embodiments of the present disclosure are the same as those usually understood by a person skilled in the technical field. Terms used in the embodiments of the present disclosure are only intended to describe the embodiments of the present disclosure, and are not intended to limit the present disclosure.

During example application of the relevant data collection and processing in the embodiments of the present disclosure, the informed consent or individual consent of a personal information subject needs to be acquired in strict accordance with the requirements of relevant laws and regulations, and the subsequent data use and processing behavior is carried out within the scope of authorization of laws and regulations and the personal information subject.

Before the embodiments of the present disclosure are further described in detail, nouns and terms involved in the embodiments of the present disclosure are described. The nouns and terms involved in the embodiments of the present disclosure are applicable to the following explanations.
1) A client is an application (APP) that runs on an electronic device and is configured to provide various services, for example, a client supporting image generation.
2) "In response to" is configured for indicating a condition or state on which a performed operation depends. When the condition or state on which the performed operation depends is satisfied, one or more performed operations may be performed in real time, or may be performed after a set delay. Unless particularly described, there is no limitation to the order in which a plurality of operations are performed.
3) A diffusion model is a generation model. Noise is first introduced into the diffusion model, and then an image is generated through denoising. Through multiple iterations over a period of time, the diffusion model learns to generate a new image each time given some noise inputs. The diffusion model mentioned in the embodiments of the present disclosure is similar to an image-to-image structure in a stable diffusion model. Herein, a picture is converted into features, and the converted features are inputted to the image-to-image structure, so that the image-to-image structure has a capability of generating other similar pictures having the features of the picture.
4) Image encoding features, alternatively referred to as image embedding, may be extracted using models such as a contrastive language-image pre-training (CLIP) model. Image embedding may be understood as converting an image into a meaningful vector representation using a model. In this process, visual features of the image are extracted, helping to realize higher-level image understanding and generation tasks.
5) Text encoding features, alternatively referred to as text embedding, may also be obtained through extraction using models such as the CLIP model. Text embedding may be understood as converting a piece of text into a meaningful vector representation using a model. In this process, expression features of the text are extracted, helping to realize higher-level image understanding and generation tasks.
6) A variational autoencoder (VAE) is a generation model and includes an encoder and a decoder. The encoder is configured to compress input high-dimensional image data into a low-dimensional latent vector, and this process may be considered as "encoding" the image. The decoder performs an inverse operation, decoding the latent vector into a high-dimensional image space to restore the original image as much as possible. The stable diffusion model generates images based on the diffusion process, and the VAE in the stable diffusion model is configured to improve the efficiency and quality of image generation. Specifically, before the stable diffusion model generates an image, the VAE may map the noise or text vector in a latent space to a form that is easier to process, or apply a post-processing operation such as a particular filter effect to the generated image.

Embodiments of the present disclosure provide an image generation method and apparatus, an electronic device, a computer-readable storage medium, and a computer program product, capable of improving an image generation effect. Hereinafter, the embodiments of the present disclosure will be described in detail based on the descriptions of the nouns and terms involved in the foregoing embodiments of the present disclosure.

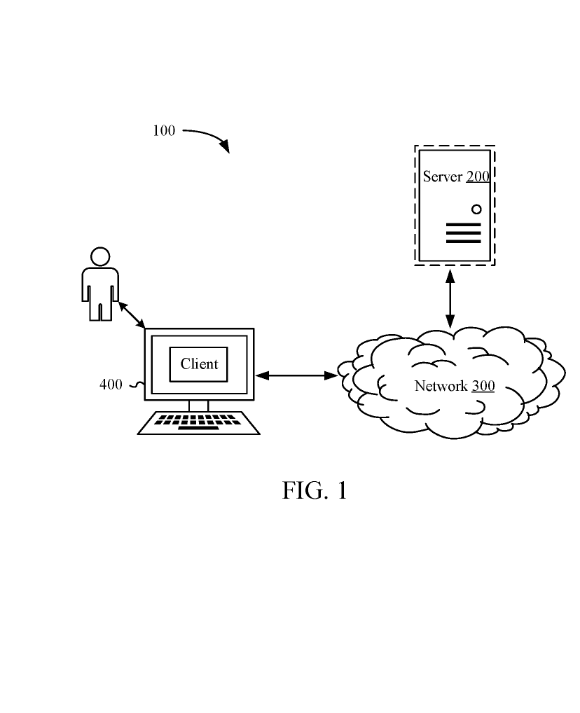

An image generation system provided in an embodiment of the present disclosure is described below. FIG. 1 is a schematic architectural diagram of an image generation system according to an embodiment of the present disclosure. To support exemplary application, an image generation system 100 includes: a server 200, a network 300, and a terminal 400. The terminal 400 is connected to the server 200 through the network 300. The network 300 may be a wide area network, a local area network, or a combination of the two. Data transmission is realized using a wireless or a wired link.

In some embodiments, the terminal 400 (for example, on which a client supporting image generation runs) transmits an image generation request to the server 200 in response to an image generation instruction. The image generation request carries an object image and image description text configured for image generation. The image description text is configured for describing an object in a to-be-generated target object image. The server 200 receives the image generation request transmitted by the terminal 400; acquires, in response to the image generation request, an initial object image and the image description text from the image generation request; perform first encoding on the initial object image to obtain image encoding features, and performs second encoding on the image description text to obtain text encoding features; generates a target object image using a diffusion model based on the image encoding features, the text encoding features, and preset noise; and returns the target object image to the terminal 400. The terminal 400 receives the target object image returned by the server 200 and displays the target object image.

In some embodiments, the terminal 400 (for example, on which the client supporting image generation runs) responds to the image generation instruction, the image generation request carrying the initial object image and the image description text configured for image generation; extracts the initial object image and the image description text from the image generation request; performs first encoding on the object image to obtain image encoding features, and performs second encoding on the image description text to obtain text encoding features; generates a target object image using the diffusion model based on the image encoding features, the text encoding features, and the preset noise; and displays the target object image.

The image generation method provided in this embodiment of the present disclosure may be applied to various scenes in which an image needs to be generated, for example, a creative design scene and a game development scene. Descriptions are provided below using examples.
1) Creative design scene: For example, a terminal receives an initial object image (for example, an image including a future city) and image description text (for example, a "cyberpunk-style future city") that are inputted by a user, and initiates an image generation request to a server. The server generates a high-definition and cyberpunk-style future city based on the image generation request. However, the terminal is available to the user for secondary editing or direct use.
2) Game development: For example, a terminal transmits a received initial object image (for example, an image including a volcano) and image description text (for example, a "scene of medieval dragon knight and volcano") that are submitted by a developer to a cloud cooperation platform. A server of the cooperation platform generates a concept image of the "scene of medieval dragon knight and volcano", and synchronizes the concept image to a terminal of a team member to support real-time feedback and iteration.
3) Business and marketing: For example, the server generates multiple versions of pictures of a "summer beach beverage" based on an initial object image (for example, an image including a beverage can) and image description text (for example, a "summer beach beverage") that are submitted by a user, and stores the pictures in the cloud. A marketer browses, through the terminal, the pictures of the "summer beach beverage" generated by previewing a web page on the cloud, selects a picture, and then downloads the picture to the local for deployment.

The image generation method provided in this embodiment of the present disclosure is implemented by an electronic device, for example, may be separately implemented by a terminal, may be separately implemented by a server, or may be collaboratively implemented by the terminal and the server. The electronic device may be various types of terminals or servers. As an example, the server (for example, the server 200) may be an independent physical server, may be a server cluster or a distributed system including a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), and a big data and artificial intelligence platform. The terminal (for example, the terminal 400) may be a notebook computer, a tablet computer, a desktop computer, a smartphone, a smart voice interaction device (for example, a smart speaker), a smart appliance (for example, a smart television), a smart watch, an in-vehicle terminal, a wearable device, a virtual reality (VR) device, an aircraft, or the like, but is not limited thereto. The terminal may be directly or indirectly connected to the server in a wired or wireless communication manner. This is not limited in this embodiment of the present disclosure.

In some embodiments, the terminal or the server may implement the image generation method provided in this embodiment of the present disclosure by running various computer-executable instructions or computer programs. For example, the computer-executable instruction may be a microprogram-level command, a machine instruction, or a software instruction. The computer program may be a native program or a software module in an operating system, may be a native APP, i.e., a program that needs to be installed in the operating system to run, such as an APP supporting image generation, or may be a mini program that can be embedded in any APP, i.e., a program that only needs to be downloaded into a browser environment to run. In summary, the foregoing computer-executable instruction may be an instruction in any form, and the foregoing computer program may be an APP, a module, or a plug-in in any form.

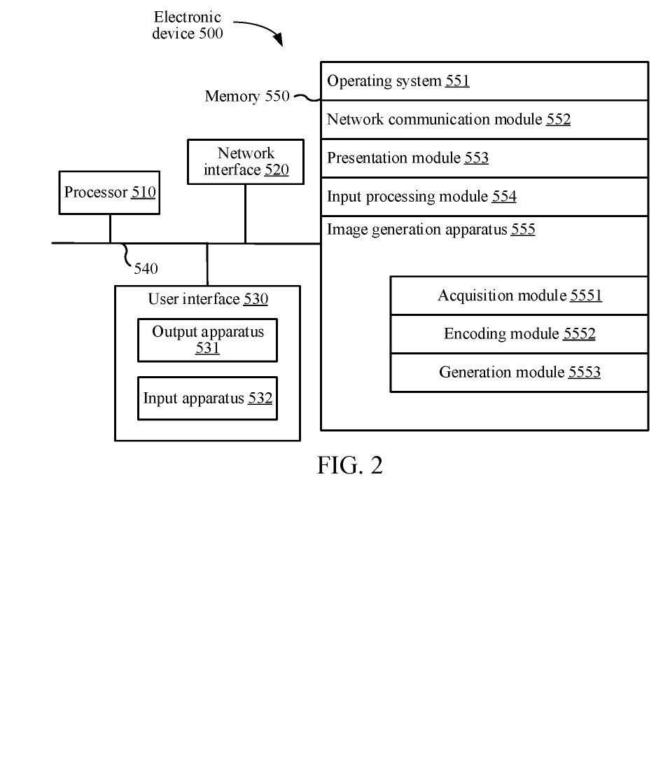

An electronic device implementing the image generation method provided in this embodiment of the present disclosure is described below. FIG. 2 is a schematic structural diagram of an electronic device according to an embodiment of the present disclosure. An electronic device 500 provided in this embodiment of the present disclosure may be a terminal or a server. As shown in FIG. 2, the electronic device 500 includes: at least one processor 510, a memory 550, at least one network interface 520, and a user interface 530. Assemblies in the electronic device 500 are coupled together through a bus system 540. The bus system 540 is configured to implement connection and communication between the assemblies. In addition to a data bus, the bus system 540 further includes a power bus, a control bus, and a state signal bus. However, for clear description, all types of buses in FIG. 2 are marked as the bus system 540.

The processor 510 may be an integrated circuit chip with a signal processing capability, such as a general-purpose processor, a digital signal processor (DSP), or another programmable logic device, discrete gate, transistor logic device, or discrete hardware assembly. The general-purpose processor may be a microprocessor, any processor, or the like.

The user interface 530 includes one or more output apparatuses 531 that enable presentation of media content, including one or more speakers and/or one or more visual displays. The user interface 530 further includes one or more input apparatuses 532, including user interface components that facilitate user input, such as a keyboard, a mouse, a microphone, a touchscreen display, a camera, and other input buttons and controls.

The memory 550 may be removable, non-removable, or a combination thereof. The memory 550 may include one or more storage devices physically located away from the processor 510. The memory 550 includes a volatile memory or a non-volatile memory, or may include both the volatile memory and the non-volatile memory. The non-volatile memory may be a read only memory (ROM). The volatile memory may be a random access memory (RAM). The memory 550 described in this embodiment of the present disclosure is intended to include any suitable type of memory.

In some embodiments, the memory 550 can store data to support various operations. Examples of the data include a program, a module, and a data structure, or their subsets or supersets, which are exemplified below.

An operating system 551 includes a system program configured for processing various basic system services and performing hardware-related tasks, such as a framework layer, a core library layer, or a driver layer, to implement various basic businesses and process the hardware-based tasks.

A network communication module 552 is configured to connect to other electronic devices via one or more (wired or wireless) network interfaces 520. The exemplary network interfaces 520 include Bluetooth, wireless fidelity (WiFi), a universal serial bus (USB), and the like.

A presentation module 553 is configured to enable presentation of information (for example, a user interface for operating peripheral devices and displaying content and information) via one or more output apparatuses 531 (for example, a display or a speaker) associated with the user interface 530.

An input processing module 554 is configured to detect one or more user inputs or interactions from one of the one or more input apparatuses 532, and translate the detected input or interaction.

In some embodiments, an image generation apparatus provided in this embodiment of the present disclosure may be implemented in a software manner. FIG. 2 shows an image generation apparatus 555 stored in the memory 550. The image generation apparatus 555 may be software in the form of a program, a plug-in, or the like, and includes the following software modules: an acquisition module 5551, an encoding module 5552, and a generation module 5553. These modules are logical, and therefore may be combined in different manners or further split according to implemented functions. The functions of the modules will be described below.

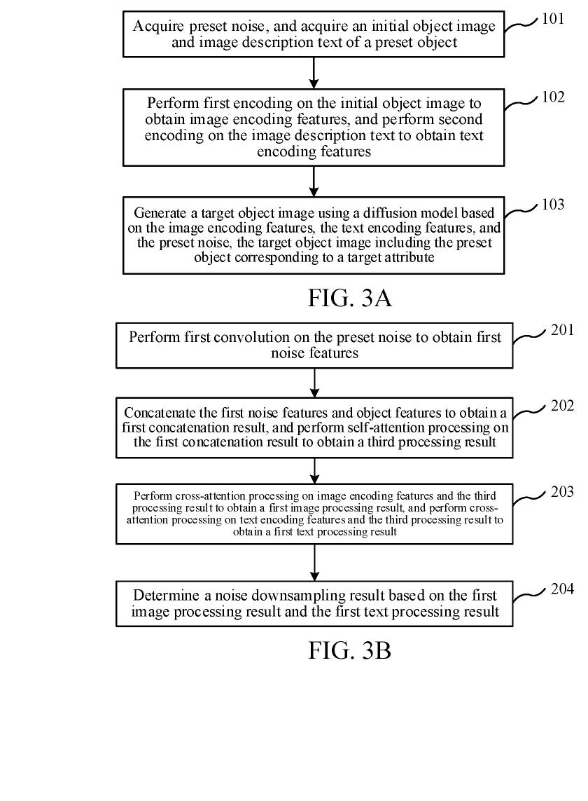

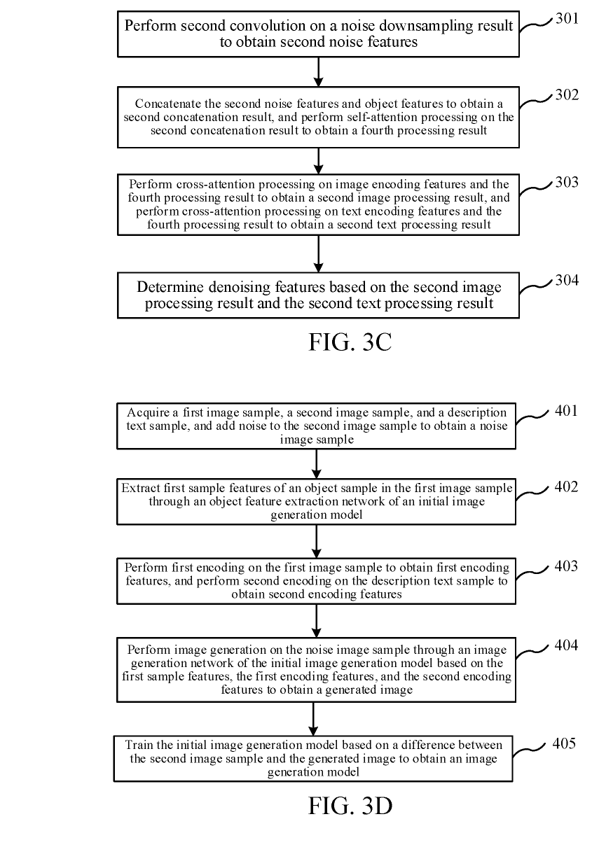

The image generation method provided in this embodiment of the present disclosure is described below. As described above, the image generation method provided in this embodiment of the present disclosure is implemented by an electronic device, for example, may be separately implemented by a server or a terminal, or may be collaboratively implemented by the server and the terminal. Therefore, the execution subject of the operations is not repeatedly described below. FIG. 3A is a schematic flowchart of an image generation method according to an embodiment of the present disclosure. The image generation method provided in this embodiment of the present disclosure includes the following operations.

Operation 101: Acquire preset noise, and acquire an initial object image and image description text of a preset object.

The image description text is configured for describing a target attribute of the preset object, that is, describing the preset object in a to-be-generated target object image. For example, if the image description text is a "cyberpunk-style future city", the image description text describes that the preset object in the to-be-generated target object image is the "cyberpunk-style future city". If the image description text is a "summer beach beverage", the image description text describes that the preset object in the to-be-generated target object image is the "summer beach beverage".

Herein, the preset noise may be generated. For example, the preset noise may be obtained through sampling from a target distribution. The target distribution includes a plurality of pieces of random data that conform to a particular data distribution type (such as a normal distribution (Gaussian distribution), a standard normal distribution, or a uniform distribution). The random data that conforms to the particular data distribution type may be generated based on a random data generation algorithm. For example, the preset noise may be Gaussian noise, Poisson noise, salt-and-pepper noise, white Gaussian noise, or the like. Using the preset noise being Gaussian noise as an example, random data that conforms to a Gaussian distribution may be generated through a random data generation algorithm, then a target random number that conforms to the Gaussian distribution is obtained through sampling from the random data that conforms to the Gaussian distribution, and the target random number that conforms to the Gaussian distribution is used as the preset noise.

Herein, in this embodiment of the present disclosure, the initial object image is further obtained. The initial object image is configured for image generation, and may be understood as a reference image for generating the target object image. The object image includes a preset object. The preset object may be a virtual object, for example, a virtual person, a virtual animal, a virtual substance, a virtual animation character, or a virtual game character. The preset object may alternatively be a real object, for example, a real person or object. The preset object may be a two-dimensional object or a three-dimensional (3D) object.

In some embodiments, the initial object image may be acquired by performing the following operations: acquiring a candidate object image including the preset object; determining a target region in the candidate object image that is different from a region where the preset object is located; and covering the target region in the candidate object image to obtain the initial object image.

For example, object region recognition may be performed on the candidate object image, and a region in the candidate object image where the object is located is determined. Then, the target region in the candidate object image that is different from the region where the preset object is located is determined, and finally the target region in the candidate object image is covered to obtain the initial object image. In this way, interference of useless information in the initial object image can be reduced, thereby improving an image generation effect of generating the target object image (including the preset object) with reference to the initial object image.

Herein, in this embodiment of the present disclosure, the image description text is further acquired. The image description text is also configured for generating the target object image. Similar to the foregoing initial object image, the image description text is also reference information for generating the target object image. The target object image includes the preset object. The image description text is configured for describing the target attribute of the preset object. For example, the image description text may describe a target attribute such as a background of the preset object. That is, the image description text may describe any target attribute related to the preset object but not of the preset object. For example, the image description text may be that: a person (i.e., the preset object) sits in a coffee shop at noon; when the morning light illuminates the room, a person (i.e., the preset object) walks onto the balcony; in the evening, under the golden afterglow of the setting sun, a person walks along the riverbank, and so on. For example, the image description text may describe a target attribute such as clothing, a posture, an action, or an accessory of the preset object. That is, the image description text may describe any target attribute of the preset object. For example, the image description text may be that: a person (i.e., the preset object) is dancing; a person (i.e., the preset object) wears a red coat, and so on. In actual application, the image description text may be set by a user according to requirements, or may be automatically generated according to user requirements through a text generation model (for example, a pre-trained large model).

Operation 102: Perform first encoding on the initial object image to obtain image encoding features, and perform second encoding on the image description text to obtain text encoding features.

The image encoding features are low-dimensional dense vector representations (i.e., features of an image domain) obtained after feature extraction and compression are performed on the input initial object image through a neural network. The image encoding features retain key visual information (such as a shape, texture, and a spatial structure) of the initial object image, and meanwhile, filter redundant details, providing a visual condition input for subsequent image generation. The text encoding features are vector representations (i.e., features of a text field) obtained after semantic encoding is performed on the image description text through a natural language processing model. The text encoding features capture high-level semantic information (such as an object category, an attribute, and a relationship) of the image description text, and is configured for guiding a generation process to keep semantic consistency with the description of the image description text. The two encoding features jointly form a basis of generation of multimodal conditions, and refined control of the preset noise is realized through cross-modal interaction.

Herein, image encoding is performed on the initial object image to obtain the image encoding features, which may be specifically implemented through a visual encoder. Meanwhile, text encoding may further be performed on the image description text to obtain the text encoding features, which may be specifically implemented through a text encoder.

Operation 103: Generate a target object image using a diffusion model based on the image encoding features, the text encoding features, and the preset noise, the target object image including the preset object corresponding to the target attribute.

The image encoding features retain features of an image domain of the initial object image, thereby ensuring consistency between the generated target object image and the preset object in the initial object image. In addition, the text encoding features can guide, by describing the target attribute, the diffusion model to generate an image conforming to the description of the image description text. Therefore, the image generation process of the diffusion model is controlled through the cooperation of multimodal information such as the image encoding features and the text encoding features, so as to generate the target object image that conforms to the description of the image description text and ensures the authenticity, thereby improving the image generation effect for the object.

In some embodiments, operation 103 may be implemented in the following manner: extracting object features of the preset object from the initial object image; and generating the target object image using the diffusion model based on the object features, the image encoding features, the text encoding features, and the preset noise.

The object features refer to discriminative and representative visual information extracted from the preset object (such as a substance, a person, or a scene) in the initial object image, usually focus on semantic or structural features of the preset object, and include, but are not limited to, the following dimensions: morphological features (such as a contour, a shape, or a structural relationship), appearance features (such as a color, texture, or material), semantic features (such as a category attribute, component composition, or a functional meaning), and spatial features (such as a position, a scale, or an orientation). Features of these dimensions are encoded into value vectors or high-level representations through a computer vision technology (such as a convolutional neural network or an attention mechanism), and a core objective thereof is to decouple and quantify essential visual characteristics of the preset object, so that the preset object has discriminability and interpretability in a feature space. For example, features extracted from an image of a cat may include key information such as "pointed ears", "hair texture", and "prone posture". The image encoding features are embedding vectors obtained after overall representation learning is performed on the initial object image through the neural network. The image encoding features not only integrate core information of object features, but also contain context information such as an image background, texture, and illumination, to form a more comprehensive multi-level feature expression suitable for subsequent image generation tasks. In short, the object features are basic components of the image encoding features, and the image encoding features are deep integration and abstract representations of the object features and visual information associated with the object features.

In some embodiments, the image encoding features may include the object features.

Herein, the object features of the preset object are extracted. The object features may be extracted through a feature extraction model obtained through pre-training. The embodiments of the present disclosure provide an object feature extraction network. The object feature extraction network may be constructed based on a Unet, and the Unet includes a downsampling network and an upsampling network. Based on this, in some embodiments, the object features include first object features and second object features. The object features of the object in the object image may be extracted by performing the following operations: performing third encoding on the initial object image to obtain object encoding features; downsampling the initial object image based on the object encoding features to obtain the first object features; and upsampling the first object features based on the object encoding features to obtain the second object features.

Downsampling refers to compressing the object encoding features by reducing the data resolution or dimension. Methods such as pooling or strided convolution may be adopted to reduce a calculation amount while retaining key information, thereby obtaining first object features with higher-level semantic representations. Upsampling refers to restoring or extending low-resolution first object features in a space dimension through a technology such as interpolation, transposed convolution, or pixel shuffle, and generating, in combination with detail information of the object encoding features, second object features with a higher resolution and richer details. In summary, downsampling focuses on information compression (such as reducing spatial dimensions and increasing the number of channels) to extract abstract features. Upsampling focuses on information reconstruction (such as increasing spatial dimensions and reducing the number of channels) to restore detailed structures.

For example, third encoding is first performed on the initial object image to obtain the object encoding features. A process of the third encoding may be implemented through a visual encoder. Then, the initial object image is downsampled based on the object encoding features to obtain the first object features. That is, a downsampling process of the initial object image is controlled based on the object encoding features, to improve a downsampling effect for the initial object image. Finally, the first object features are upsampled based on the object encoding features to obtain the second object features. That is, an upsampling process of the first object features is controlled based on the object encoding features, to improve an upsampling effect for the object image, thereby improving an expression capability of the extracted object features for the object in the object image and facilitating the subsequent image generation process implemented based on the object features.

In this way, a multi-scale object feature extraction mechanism (generating the first object features through downsampling, and generating the second object features through upsampling) is introduced to this embodiment of the present disclosure. High-level semantic information (such as an overall structure and a category attribute) of the initial object image is captured through downsampling, and partial detail features (such as texture and edge) are restored through upsampling, to form complementary multi-scale representations, thereby enhancing structural appropriateness and detail richness of the generated image and significantly improving the precision and controllability of image generation.

In some embodiments, based on the object encoding features, the initial object image may be downsampled to obtain the first object features by performing the following operations: performing first convolution on the initial object image to obtain first convolution features; performing self-attention processing on the first convolution features to obtain a first processing result; and performing cross-attention processing on the object encoding features and the first processing result to obtain the first object features. Correspondingly, based on the object encoding features, the first object features may be upsampled to obtain the second object features by performing the following operations: performing second convolution on the first object features to obtain second convolution features; performing self-attention processing on the second convolution features to obtain a second processing result; and performing cross-attention processing on the object encoding features and the second processing result to obtain the second object features.

Self-attention processing refers to modeling a dependency relationship between internal elements of input features (such as first convolution features or second convolution features), and dynamically aggregating global context information by calculating similarity weights between each position and other positions in the input features, thereby enhancing the representation capability of output features. For example, in image processing, self-attention can capture long-distance spatial or channel associations, enabling the model to focus more on salient regions related to tasks (such as image generation tasks). Cross-attention processing refers to establishing an interaction relationship between different feature modalities or levels (for example, the object encoding features and the first processing result, or the object encoding features and the second processing result) to guide information fusion using a query-key-value mechanism. For example, in the downsampling or upsampling process, the object encoding features are used as queries to perform key value retrieval on a self-attention processing result (for example, the first processing result or the second processing result), thereby dynamically aligning high-level semantic information and local detailed features and generating more discriminative output features (for example, the first object features or the second object features). In summary, self-attention processing focuses on global relationship modeling within a single feature, whereas cross-attention processing focuses on cross-modal or cross-level information interaction among multiple features.

For example, the downsampling network includes a first convolutional network (configured for downsampling), a self-attention processing layer, and a cross-attention processing layer. Based on this, the downsampling process includes: first performing first convolution on the initial object image to obtain first convolution features; then, performing self-attention processing on the first convolution features to obtain a first processing result; and finally, performing cross-attention processing on the object encoding features and the first processing result to obtain the first object features. In this way, the control of the object encoding features of the initial object image is added at the cross-attention processing layer of the downsampling network, and the downsampling effect for the initial object image can be improved.

Similarly, the upsampling network includes a second convolutional network (configured for upsampling), a self-attention processing layer, and a cross-attention processing layer. Based on this, the upsampling process includes: first performing second convolution on the first object features to obtain second convolution features; then, performing self-attention processing on the second convolution features to obtain a second processing result; and finally, performing cross-attention processing on the object encoding features and the second processing result to obtain the second object features. In this way, the control of the object encoding features of the initial object image is also added at the cross-attention processing layer of the upsampling network, and the upsampling effect for the initial object image can be improved, thereby improving an expression capability of the extracted object features for the object in the initial object image and facilitating the subsequent image generation process implemented based on the object features.

In this way, in this embodiment of the present disclosure, a hierarchical attention feature pyramid is constructed to provide a more robust multi-granularity condition input for the generation process of the target object image. After local features are captured through convolution, a long-range dependency relationship (for example, global structure or texture association) is modeled with reference to a self-attention mechanism, and then the object encoding features and the processing result are dynamically fused through cross-attention. Meanwhile, local details and global semantic consistency are both considered to realize refined feature extraction. In the upsampling and downsampling processes, the object encoding features are used as a unified medium, and image, text, and noise feature spaces are bridged through cross-attention to ensure that a generated result strictly follows the text description and retains key attributes (such as a style and a posture) of the initial object image, thereby realizing cross-modal feature alignment. The staged downsampling-upsampling structure (cooperated with the attention mechanism) effectively alleviates the information loss during a single-scale feature extraction, enabling more stable generation of high-resolution, detail-rich target object images especially under complex scenes.

In some embodiments, a downsampling process is implemented through M downsampling layers, and M is an integer greater than 1. Based on this, the object image may be downsampled based on the object encoding features to obtain the first object features by performing the following operations: downsampling the object image based on the object encoding features through a first downsampling layer of the M downsampling layers to obtain a layer downsampling result of the first downsampling layer; downsampling a layer downsampling result of an (i-1)^{th} downsampling layer based on the object encoding features through an i^{th} downsampling layer of the M downsampling layers to obtain a layer downsampling result of the i^{th} downsampling layer; traversing i to obtain a layer downsampling result of an M^{th} downsampling layer, i being an integer greater than 1 and less than or equal to M; and using a layer downsampling result of each downsampling layer as the first object feature.

Herein, the downsampling network includes M downsampling layers, and the downsampling process is implemented through the M downsampling layers. Each downsampling layer includes a first convolutional network (configured for downsampling), a self-attention processing layer, and a cross-attention processing layer.

Based on this, the object image is first downsampled based on the object encoding features through the first downsampling layer of the M downsampling layers to obtain the layer downsampling result of the first downsampling layer. A layer downsampling process of the first downsampling layer may refer to the foregoing downsampling process, and the implementation logic is the same. For the i^{th} downsampling layer of the M downsampling layers, the layer downsampling result of the (i–1)^{th} downsampling layer is downsampled based on the object encoding features to obtain the layer downsampling result of the i^{th} downsampling layer. A layer downsampling process of the i^{th} downsampling layer may refer to the foregoing downsampling process, and the implementation logic is the same. i is traversed to obtain the layer downsampling result of the M^{th} downsampling layer. In this way, the layer downsampling results of the downsampling layers are used as the foregoing first object features. i herein may start from 1 until traversing to M. In the traversing process, i is increased by 1 each time.

In this way, M cascaded downsampling is performed on the object image based on the object encoding features through the M downsampling layers to obtain M first object features, thereby improving a downsampling effect for the object image, enabling extraction of more effective features, and improving an expression capability of the finally obtained object features.

In some embodiments, an upsampling process is implemented through M upsampling layers, and an i^{th} upsampling layer of the M upsampling layers corresponds to the i^{th} downsampling layer. Based on this, the first object features may be upsampled based on the object encoding features to obtain the second object features by performing the following operations: upsampling the first object features based on the object encoding features through an M^{th} upsampling layer of the M upsampling layers to obtain a layer upsampling result of the M^{th} upsampling layer; concatenating the layer downsampling result of the i^{th} downsampling layer and a layer upsampling result of an (i+1)^{th} upsampling layer to obtain a concatenation result of the i^{th} upsampling layer, and upsampling the concatenation result of the i^{th} upsampling layer based on the object encoding features through the i^{th} upsampling layer to obtain a layer upsampling result of the i^{th} upsampling layer; traversing i to obtain a layer upsampling result of a first upsampling layer; and using a layer upsampling result of each upsampling layer as the second object feature.

Herein, the upsampling network includes M upsampling layers, and each upsampling layer includes a second convolutional network (configured for upsampling), a self-attention processing layer, and a cross-attention processing layer. The i^{th} upsampling layer of the M upsampling layers corresponds to the i^{th} downsampling layer of the M downsampling layers, and the first upsampling layer corresponds to the first downsampling layer, that is, a second upsampling layer corresponds to a second downsampling layer, a third upsampling layer corresponds to a third downsampling layer, …, an (M–1)^{th} upsampling layer corresponds to an (M–1)^{th} downsampling layer, and the M^{th} upsampling layer corresponds to the M^{th} downsampling layer.

Based on this, the first object features are first upsampled based on the object encoding features through the M^{th} upsampling layer of the M upsampling layers to obtain the layer upsampling result of the M^{th} upsampling layer. A layer upsampling process of the M^{th} upsampling layer may refer to the foregoing upsampling process, and the implementation logic is the same. For the i^{th} upsampling layer, the layer downsampling result of the i^{th} downsampling layer is first acquired. Then, the layer downsampling result of the i^{th} downsampling layer and the layer upsampling result of the (i+1)^{th} upsampling layer are concatenated to obtain the concatenation result of the i^{th} upsampling layer. The concatenation process may include processing such as addition and multiplication of the two. Further, the concatenation result of the i^{th} upsampling layer is upsampled based on the object encoding features through the i^{th} upsampling layer to obtain the layer upsampling result of the i^{th} upsampling layer. A layer upsampling process of the i^{th} upsampling layer may refer to the foregoing upsampling process, and the implementation logic is the same. i is traversed to obtain the layer upsampling result of the first upsampling layer. In this way, the layer upsampling results of the upsampling layers are used as the foregoing second object features. i herein may start from M until traversing to 1. In the traversing process, i is decreased by 1 each time.

In this way, M cascaded upsampling is performed on the first object features with reference to the object encoding features through the M upsampling layers to obtain M second object features, thereby improving an upsampling effect for the first object features, enabling extraction of more effective features, and improving an expression capability of the finally obtained object features.

Herein, image generation is performed using the diffusion model based on the object features, the image encoding features, the text encoding features, and the preset noise to obtain the target object image. In this way, generation of the target object image including the object is controlled through the cooperation of the object features, the image encoding features, and the text encoding features, to ensure that the target object image has the object features, the image encoding features, and the text encoding features, thereby improving an image generation effect for the preset object.

In some embodiments, generating the target object image using the diffusion model based on the object features, the image encoding features, the text encoding features, and the preset noise may be implemented in the following manner: performing the following processing using the diffusion model: denoising the preset noise based on the object features, the image encoding features, and the text encoding features to obtain denoising features; and performing image reconstruction on the denoising features to obtain the target object image.

Denoising refers to a process of extracting effective features by gradually eliminating random interference components from preset noise based on multimodal condition information such as object features, image encoding features, and text encoding features. Image reconstruction refers to a process of decoding denoising features obtained after denoising into a target object image that conforms to the description of the image description text and that has the visual appropriateness. The two stages jointly constitute a core process of conditional image generation, where denoising is configured for feature extraction, and image reconstruction is configured for pixel-level synthesis, finally realizing end-to-end generation from noise to high-quality images.

Herein, the image generation process actually includes the denoising process of the preset noise. That is, the preset noise is denoised based on the object features, the image encoding features, and the text encoding features to obtain the denoising features. Then, image reconstruction is performed on the denoising features to obtain the target object image. In actual application, the image reconstruction process may be implemented through decoding, that is, the denoising features are decoded to obtain the target object image. For example, the denoising features may be decoded through a decoder of a VAC model to obtain the target object image.

In this way, in this embodiment of the present disclosure, the image generation process is clearly divided into two stages, i.e., denoising and image reconstruction, thereby significantly improving the quality and controllability of the generation effect. The beneficial effects are mainly as follows: 1) First, the multimodal conditions (object features, image encoding features, and text encoding features) are adopted to guide the gradual removal of noise to retain semantic consistency, and then details are restored through the reconstruction stage, so that the generation process is more stable, thereby realizing stage-wise optimization. 2) In the denoising stage, features of different modalities may be fused in a targeted manner to accurately control the generated content, while the reconstruction stage focuses on visual quality improvement. The two stages have a clear division of labor.

In some embodiments, a denoising process includes T denoising, and T is an integer greater than 1. Based on this, the preset noise may be denoised based on the object features, the image encoding features, and the text encoding features to obtain denoising features by performing the following operations: performing first denoising on the preset noise based on the object features, the image encoding features, and the text encoding features to obtain intermediate denoising features outputted by the first denoising; performing, based on the object features, the image encoding features, and the text encoding features, t^{th} denoising on intermediate denoising features outputted by (t–1)^{th} denoising, to obtain intermediate denoising features outputted by the t^{th} denoising, t being an integer greater than 1 and less than or equal to T; and traversing t to obtain intermediate denoising features outputted by T^{th} denoising, and using the intermediate denoising features outputted by the T^{th} denoising as the denoising features. t herein may start from 1 until traversing to T. In the traversing process, t is increased by 1 each time.

The denoising process is a back diffusion process in diffusion model processing, that is, T denoising is performed on the preset noise to gradually remove the noise to obtain the denoising features. The T denoising may be understood as denoising over T time steps, with one denoising performed at each time step. Each denoising process may be implemented through the denoising logic provided in this embodiment of the present disclosure. In this way, a denoising effect of the preset noise can be improved, to generate the target object image for the object, thereby improving an image generation effect for the object.

In this way, in this embodiment of the present disclosure, the fineness and stability of image generation are significantly improved through a progressive multi-round denoising mechanism. The beneficial effects are mainly as follows: 1) The features are gradually refined through T iterative denoising (T > 1), so that in the generation process, noise can be eliminated hierarchically and key semantic information is retained, thereby avoiding the detail loss that may be caused by single denoising. 2) The object features, the image encoding features, and the text encoding features (i.e., the multimodal conditions) are recombined in each denoising iteration to ensure that the multimodal conditions can effectively guide the generation direction under different noise intensities. 3) The stepwise intermediate denoising feature output provides a debuggable intermediate state for the generation process, which not only facilitates viewing the generation quality but also reduces the risk of error accumulation of single denoising, making it particularly suitable for the stable generation of high-resolution images.

In some embodiments, the preset noise may be denoised based on the object features, the image encoding features, and the text encoding features to obtain denoising features by performing the following operations: downsampling the preset noise based on the object features, the image encoding features, and the text encoding features to obtain a noise downsampling result; and upsampling the noise downsampling result based on the object features, the image encoding features, and the text encoding features to obtain the denoising features.

A downsampling principle in "downsampling the preset noise" is similar to the foregoing downsampling principle, and an upsampling principle in "upsampling the noise downsampling result" is similar to the foregoing upsampling principle. Details are not described herein again.

Herein, the denoising process may be implemented through an image generation network (pretrained Unet), and the image generation network may further be constructed based on a Unet. The image generation network also includes a downsampling network and an upsampling network. Based on this, the preset noise is downsampled based on the object features, the image encoding features, and the text encoding features to obtain the noise downsampling result. That is, the downsampling process of the preset noise is controlled based on the object features, the image encoding features, and the text encoding features to improve a downsampling effect for the preset noise. Finally, the noise downsampling result is upsampled based on the object features, the image encoding features, and the text encoding features to obtain the denoising features. That is, the upsampling process of the noise downsampling result is controlled based on the object features, the image encoding features, and the text encoding features to improve an upsampling effect for the noise downsampling result, thereby improving the accuracy of the obtained denoising features and improving an image effect of the target object image reconstructed based on the denoising features subsequently.

In this way, in this embodiment of the present disclosure, the quality and efficiency of image generation are significantly improved by constructing a multi-scale hierarchical denoising architecture. The beneficial effects are mainly as follows: 1) The noise and effective features are separated in a low-dimensional space through a downsampling operation, filtering out noise while retaining key semantic information. 2) Performing feature processing in a reduced-dimensional space greatly reduces the calculation complexity, and in the subsequent upsampling process, detailed features are accurately restored through a cross-layer connection, thereby balancing calculation resources and generation quality. 3) Cross-modal fusion enhancement: the object features, the image encoding features, and the text encoding features are fused at both the downsampling stage and the upsampling stage to ensure that the multimodal condition information can effectively guide a denoising direction at feature spaces of different scales, finally generating a high-quality image that conforms to the description of the image description text and that ensures the visual continuity.

In some embodiments, referring to FIG. 3B, the preset noise may be downsampled based on the object features, the image encoding features, and the text encoding features to obtain the noise downsampling result by performing the following operations: operation 201: performing first convolution on the preset noise to obtain first noise features; operation 202: concatenating the first noise features and the object features to obtain a first concatenation result, and performing self-attention processing on the first concatenation result to obtain a third processing result; operation 203: performing cross-attention processing on the image encoding features and the third processing result to obtain a first image processing result, and performing cross-attention processing on the text encoding features and the third processing result to obtain a first text processing result; and operation 204: determining the noise downsampling result based on the first image processing result and the first text processing result.

A principle of the self-attention processing of operation 202 is similar to that of the foregoing self-attention processing, and a principle of the cross-attention processing of operation 203 is similar to that of the foregoing cross-attention processing. Details are not described herein again.

Herein, the downsampling network includes M downsampling layers, and each downsampling layer includes a first convolutional network (configured for downsampling), a self-attention processing layer, and a cross-attention processing layer. Based on this, the downsampling process for the preset noise includes the following operations.

For operation 201, first convolution may be performed on the preset noise using the first convolutional network to obtain the first noise features. The first convolutional network is configured for downsampling the preset noise.

Herein, the foregoing object features may be added to each self-attention processing layer of the image generation network. Since the foregoing object feature extraction network also includes a downsampling network and an upsampling network, the first object features outputted by the downsampling network of the object feature extraction network may be added to the self-attention processing layer of the downsampling network of the image generation network. That is, for operation 202, the first noise features and the object features (for example, the first object features) are first concatenated to obtain the first concatenation result, and then self-attention processing is performed on the first concatenation result to obtain the third processing result. In actual application, the downsampling network of the object feature extraction network and the downsampling network of the image generation network may be the same. The first object feature outputted by each downsampling layer in the downsampling network of the object feature extraction network may be inputted to a corresponding downsampling layer in the downsampling network of the image generation network for concatenating.

For operation 203, cross-attention processing is performed on the image encoding features and the third processing result to obtain the first image processing result, and cross-attention processing is performed on the text encoding features and the third processing result to obtain the first text processing result. For operation 204, the first image processing result and the first text processing result may be fused to obtain the noise downsampling result. The fusion process may be adding, multiplying, concatenating, or the like.

In this way, in this embodiment of the present disclosure, the control of the object features, the image encoding features, and the text encoding features is added in the denoising process, so that the generation effect for the target object image of the object can be improved. Through operation 202, self-attention processing is performed on the noise features and the object features after the noise features and the object features are concatenated, thereby effectively establishing an association between a noise space and the object features, and enhancing the extraction of key features. Through operation 203, the image encoding features and the text encoding features are separately adopted to perform cross-attention interaction with the processing result, thereby ensuring that the downsampling process both considers visual details and semantic consistency. Contribution weights of features of different modalities are dynamically adjusted through a dual cross-attention mechanism, so that the noise and the effective features are precisely separated, providing a purer low-dimensional feature representation for subsequent upsampling, and finally improving the structural accuracy and detail fidelity of the generated image.

In some embodiments, referring to FIG. 3C, the noise downsampling result may be upsampled based on the object features, the image encoding features, and the text encoding features to obtain the denoising features by performing the following operations: operation 301: performing second convolution on the noise downsampling result to obtain second noise features; operation 302: concatenating the second noise features and the object features to obtain a second concatenation result, and performing self-attention processing on the second concatenation result to obtain a fourth processing result; operation 303: performing cross-attention processing on the image encoding features and the fourth processing result to obtain a second image processing result, and performing cross-attention processing on the text encoding features and the fourth processing result to obtain a second text processing result; and operation 304: determining the denoising features based on the second image processing result and the second text processing result.

A principle of the self-attention processing of operation 302 is similar to that of the foregoing self-attention processing, and a principle of the cross-attention processing of operation 303 is similar to that of the foregoing cross-attention processing. Details are not described herein again.

Herein, the upsampling network includes M upsampling layers, and each upsampling layer includes a second convolutional network (configured for upsampling), a self-attention processing layer, and a cross-attention processing layer. Based on this, the upsampling process for the noise downsampling result includes the following operations.

For operation 301, second convolution may be performed on the noise downsampling result using the second convolutional network to obtain the second noise features. The second convolutional network is configured for performing upsampling on the noise downsampling result.

Herein, the foregoing object features may be added to each self-attention processing layer of the image generation network. Since the foregoing object feature extraction network also includes a downsampling network and an upsampling network, the second object features outputted by the upsampling network of the object feature extraction network may be added to the self-attention processing layer of the upsampling network of the image generation network. That is, for operation 302, the second noise features and the object features (for example, the second object features) are first concatenated to obtain the second concatenation result, and self-attention processing is performed on the second concatenation result to obtain the fourth processing result. In actual application, the upsampling network of the object feature extraction network and the upsampling network of the image generation network may be the same. The second object feature outputted by each upsampling layer in the upsampling network of the object feature extraction network may be inputted to a corresponding upsampling layer in the upsampling network of the image generation network for concatenating.

For operation 303, cross-attention processing is performed on the image encoding features and the fourth processing result to obtain the second image processing result, and cross-attention processing is performed on the text encoding features and the fourth processing result to obtain the second text processing result. For operation 304, the second image processing result and the second text processing result may be fused to obtain the denoising features. The fusion process may be adding, multiplying, concatenating, or the like.

In this way, the control of the object features, the image encoding features, and the text encoding features is added in the denoising process, so that the generation effect for the target object image of the object can be improved. Through operation 302, the noise features and the object features in the upsampling process are concatenated, and cross-attention interaction is separately performed with the image encoding features and the text encoding features through operation 303, thereby realizing multi-layer fusion of the visual features and the semantic features. A long-range dependency relationship between features is effectively modeled through the self-attention in operation 302, and the upsampling process is ensured to strictly follow the description of the image description text and maintain consistency with the input image through the cross-attention in operation 303. A feature reconstruction process is finely regulated through a dual attention mechanism (self-attention and cross-attention), so that the final denoising features not only retain key details but also conform to an expected semantic requirement, thereby providing a high-quality input for subsequent image reconstruction.

In some embodiments, the following operations may further be performed: acquiring a required object image, the required object image representing a generation requirement of the preset object in the target object image; and extracting required object features of the preset object in the required object image. Based on this, generating the target object image using the diffusion model based on the image encoding features, the text encoding features, and the preset noise may be implemented in the following manner: generating the target object image using the diffusion model based on the required object features, the object features, the image encoding features, the text encoding features, and the preset noise.

The required object features refer to semantically representative visual features extracted from the required object image for guiding the generation of the target image. Essentially, they are high-dimensional vector representations that are encoded by a neural network and that can reflect the user's generation intention (such as a style, a structure, or an attribute requirement). Specifically, two types of key information may be contained: 1) explicit requirements: visual elements (for example, an object contour, color distribution, and a texture pattern) directly parsed through image content; and 2) latent requirements: deep semantics (for example, an artistic style, an emotional tendency, or a functional constraint) obtained through reasoning.

Herein, the required object image may be set by a user according to requirements. The required object image can represent a generation requirement of the object in the target object image, and the generation requirement may include features such as a particular posture, a particular action, or a particular background of the object in the target object image. Therefore, when an image is generated, the required object features may be extracted from the required object image. For example, the required object features may be extracted from the required object image through a controllable generation network (controlnet). Further, image generation is performed on the preset noise using the diffusion model with reference to the required object features, the object features, the image encoding features, and the text encoding features to obtain the target object image.

In this way, in this embodiment of the present disclosure, through the cross-modal fusion of the required object features with the object features, the image encoding features, and the text encoding features, fine-grained control over the generation process is realized, thereby ensuring that the output target object image not only conforms to the text description but also satisfies a visual requirement inputted by the user (for example, an oil painting style of the required object image is transferred to a generated result).

In some embodiments, the required object features of the object in the required object image may be extracted by performing the following operations: extracting at least one of the following features of the required object image: depth map features of the required object image, object posture features of the preset object in the required object image, and object contour features of the preset object in the required object image.

The depth map features are geometric representations generated by estimating spatial distances (depth information) of pixels in the required object image, and are configured for controlling the 3D structure and scene hierarchy of the target object in the generation process. The object posture features are substance or person key point/skeleton structure data extracted from the required object image, for example, a motion posture or a spatial orientation of the object, and may precisely guide the action layout of the generated object. The object contour features are two-dimensional shape representations obtained through edge detection or segmentation, and define an outline boundary of the object, thereby ensuring the topological consistency between the generated result and the input requirement. The three types of structural features jointly form a multi-dimensional control signal, constraining the generation process from spatial geometry (depth), dynamic posture (key point), and static shape (contour), respectively, thereby realizing pixel-level controllable image synthesis.

In some embodiments, an image generation process is implemented through an image generation model. Referring to FIG. 3D, the image generation model may be obtained through training by performing the following operations: operation 401: acquiring a first image sample, a second image sample, and a description text sample, and adding noise to the second image sample to obtain a noise image sample, the first image sample and the second image sample each including an object sample, the description text sample describing attributes of the object sample, and a region in the first image sample that is different from a region where the object sample is located being covered; operation 402: extracting first sample features of the object sample in the first image sample through an object feature extraction network of an initial image generation model; operation 403: performing first encoding on the first image sample to obtain first encoding features, and performing second encoding on the description text sample to obtain second encoding features; operation 404: performing image generation on the noise image sample through an image generation network of the initial image generation model based on the first sample features, the first encoding features, and the second encoding features to obtain a generated image; and operation 405: training the initial image generation model based on a difference between the second image sample and the generated image to obtain the image generation model.

For operation 401, the first image sample, the second image sample, and the description text sample are acquired, and noise is added to the second image sample to obtain the noise image sample. The first image sample and the second image sample each include an object sample, and the description text sample is configured for describing an object sample in a to-be-generated generated image. A region in the first image sample that is different from the region where the object sample is located is covered. When the noise is added, the noise may be first generated. The noise may be Gaussian noise, Poisson noise, or the like. The noise is added to the second image sample to obtain the noise image sample.

For operation 402, the first sample features of the object sample in the first image sample are extracted through the object feature extraction network of the initial image generation model. Operation 402 is similar to the process of extracting the object features, and details are not described herein again.

For operation 403, image encoding is performed on the first image sample to obtain the first encoding features, and text encoding is performed on the description text sample to obtain the second encoding features. Operation 403 is similar to operation 102, and details are not described herein again.

For operation 404, image generation is performed on the noise image sample through the image generation network of the initial image generation model based on the first sample features, the first encoding features, and the second encoding features to obtain the generated image. For example, the noise image sample may be denoised through the initial image generation model based on the first sample features, the first encoding features, and the second encoding features to obtain denoising image features, and then the denoising image features are decoded to perform image reconstruction to obtain the generated image. Operation 404 is similar to operation 103, and details are not described herein again.

For operation 405, the difference between the second image sample and the generated image is acquired, and then a value of a loss function of the initial image generation model is determined based on the difference, so that model parameters of the initial image generation model are updated based on the value of the loss function to obtain the image generation model.

By applying the foregoing embodiments of the present disclosure, the target attribute of the preset object is described through the image description text. First encoding is performed on the initial object image to obtain the image encoding features, and second encoding is performed on the image description text to obtain the text encoding features. The target object image is generated using the diffusion model based on the image encoding features, the text encoding features, and the preset noise. In this way, the image encoding features retain features of an image domain of the initial object image, thereby ensuring consistency between the generated target object image and the preset object in the initial object image. In addition, the text encoding features can guide, by describing the target attribute, the diffusion model to generate an image conforming to the description of the image description text. Therefore, the image generation process of the diffusion model is controlled through the cooperation of multimodal information such as the image encoding features and the text encoding features, so as to generate the target object image that conforms to the description of the image description text and ensures the authenticity, thereby improving the image generation effect for the object.

Exemplary application of the embodiments of the present disclosure in an actual application scene is described below. First, related terms are described, including: 1) object (for example, human body) features (ID), where each object image (i.e., the foregoing initial object image) is unique; the object ID reflects appearance features of the object in the object image, including the object's facial features (ID), clothing, accessories, shoes, a hair style, and the like; and 2) an object facial ID, which refers to facial features of the object, including shapes and characteristics of the facial features.

The image generation model in the related art can only have an image generation capability of a single object ID. If an image generation capability of another object ID needs to be realized, the image generation model further needs to be fine-tuned through an image of the another object ID. That is, independent training needs to be performed for each different object ID, and the training time is relatively long.

Based on this, in this embodiment of the present disclosure, based on the diffusion model, after fine-tuning the image generation model with a set amount of object ID data in the early stage, any semantic images of the target object ID may be generated in the testing phase without further fine-tuning for the target object ID, and the generated results may be strictly consistent with the original object ID. An early-stage model fine-tuning method provided in this embodiment of the present disclosure is a training method that enables the diffusion model to have the human body ID understanding and preservation capability. In this method, through an additionally developed "subject feature preservation network" (i.e., the foregoing object feature extraction network), object image data is used as an input of the network to obtain object features. Then, the object features are used as generation conditions of the diffusion model, and the diffusion model may use the generation conditions to guide the generation of the target object image.

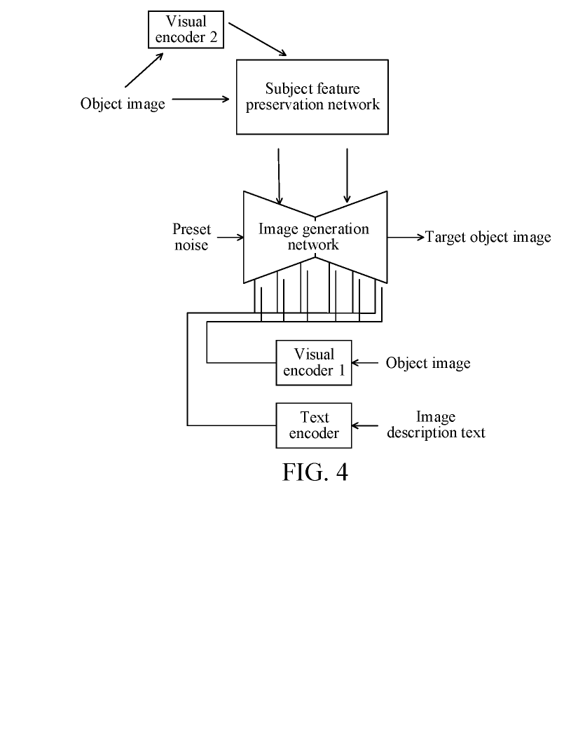

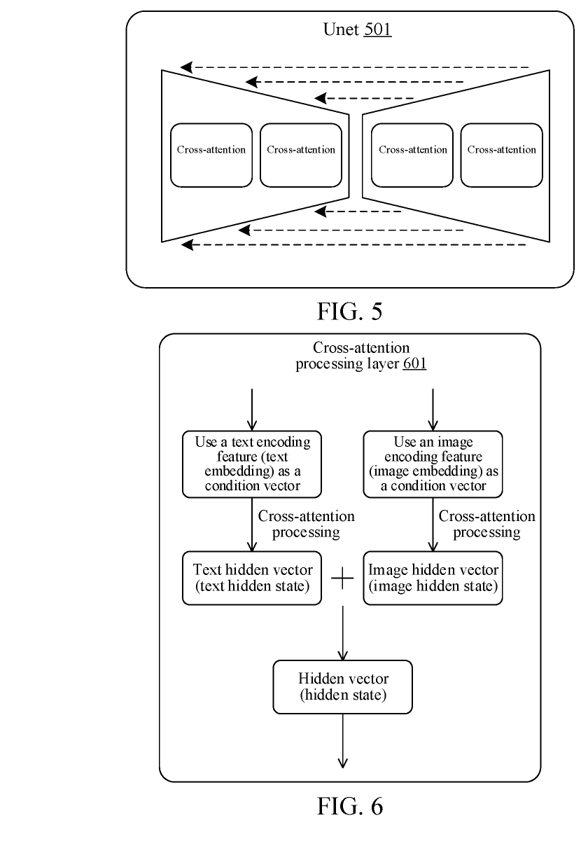

Next, the image generation method provided in this embodiment of the present disclosure is described. FIG. 4 is a schematic diagram of an image generation architecture according to an embodiment of the present disclosure. Herein, the image generation architecture configured for image generation includes: a visual encoder 1, a visual encoder 2, a text encoder, an object (or subject) feature preservation network (reference Unet), and an image generation network (pretrained Unet). The subject feature preservation network and the image generation network are both constructed based on a Unet in a stable diffusion model. A structure of the Unet is shown in FIG. 5. FIG. 5 is a schematic structural diagram of a Unet 501 according to an embodiment of the present disclosure. The Unet includes a downsampling network and an upsampling network. The downsampling network includes M downsampling layers, and each downsampling layer includes a first convolutional network (configured for downsampling), a self-attention processing layer, and a cross-attention processing layer. The upsampling network includes M upsampling layers, and each upsampling layer includes a second convolutional network (configured for upsampling), a self-attention processing layer, and a cross-attention processing layer. They will be described separately below.

For an object image (mask object image) and image description text (text prompt) that are configured for image generation, one branch performs text encoding on the image description text through a text encoder to obtain text encoding features (text embedding). The text encoder herein may be any image-text matching encoder, such as ViT-L/14 or ViT-B/32. The other branch performs image encoding on the object image through a visual encoder 1 to obtain image encoding features (image embedding). The image encoder herein may also be any image-text matching encoder, such as ViT-L/14 or ViT-B/32. A region in the object image that is different from a region where the object is located is covered. The object is a subject in the object image, and may be a real person, a virtual person (such as an animation character or a game character), a virtual substance, or the like.

Subsequently, the obtained text embedding and image embedding are jointly inputted to a cross-attention processing layer of an image generation network (pretrained Unet). An operation manner of the cross-attention processing layer is shown in FIG. 6 (FIG. 6 is a schematic diagram of a processing procedure of a cross-attention processing layer 601 according to an embodiment of the present disclosure). That is, cross-attention processing (cross-attention for text condition) is performed using the text embedding as a condition vector to obtain a text hidden vector (text hidden state). Cross-attention processing (cross-attention for image condition) is performed using the image embedding as a condition vector to obtain an image hidden vector (image hidden state). The text hidden vector (text hidden state) and the image hidden vector (image hidden state) are added to obtain a hidden vector (hidden state) outputted by the cross-attention processing layer.

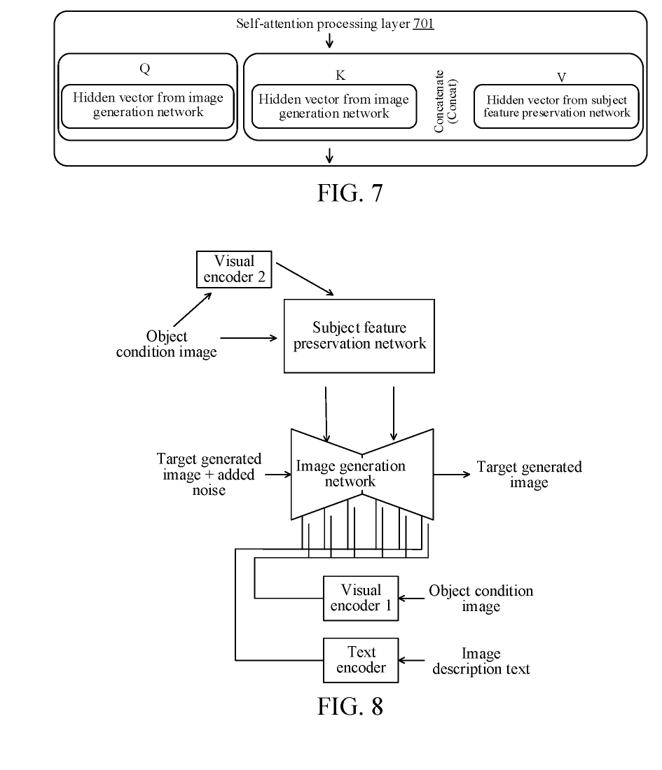

Subsequently, the subject feature preservation network receives two inputs, including: using the object image (mask object image) as a Unet input of the subject feature preservation network, and using the image embedding obtained by performing image encoding on the object image based on the visual encoder 2 as a Unet condition vector input of the subject feature preservation network. A hidden vector (embedding) inputted to each self-attention in the subject feature preservation network is saved, and the saved hidden vector is configured for each self-attention processing in the image generation network. For example, as shown in FIG. 7 (FIG. 7 is a schematic diagram of a processing procedure of a self-attention processing layer 701 according to an embodiment of the present disclosure), in the self-attention of an image generation network, hidden vectors from the subject feature preservation network (embedding from reference Unet) are used as a K variable and a V variable in the self-attention and concatenated with a K variable and a V variable in the self-attention of the image generation network. Then, a hidden vector from the image generation network (embedding from pretrained Unet) is used as a Q variable, and self-attention processing is performed based on a concatenation result.

Based on the foregoing content, when the image is generated based on the image generation architecture, at an actual usage stage (inference stage), an object image with a background region removed and image description text describing an object in the object image (for example, may describe a background environment of the object or a desired action or posture of the object) are acquired. Preset noise (for example, Gaussian noise) is generated. The object image and the image embedding of the object image are processed through the reference Unet to obtain a hidden vector. The preset noise is denoised with reference to the text embedding of the image description text, the image embedding of the object image, and the hidden vector outputted by the reference Unet to obtain denoising features. The denoising features are decoded to obtain a generated target object image (object-consistency generated image).

Next, a training process of the image generation model provided in this embodiment of the present disclosure is described. In this embodiment of the present disclosure, a diffusion model controlled based on both image embedding and text embedding is mainly trained. A specific training process includes the following operations.
1) A batch of object image samples is collected and grouped according to object IDs. Each object ID corresponds to at least two object image samples having different backgrounds or postures. The data scale is sufficient when the number of object IDs reaches more than 100,000. The object image samples are preprocessed in advance, which may specifically include: annotating frame positions of objects in the object image samples and mask images (for matting out object images except the background), grouping the object image samples according to the object IDs, and performing text description for each object image sample using a bootstrapping language-image pretraining (Blip) model or another language model, the description content including a posture, an action, and background content of the object, thereby obtaining the description text sample.
2) FIG. 8 is a schematic diagram of training of an image generation model according to an embodiment of the present disclosure. For a group of object image samples with the same object ID, one object image sample is selected as an object condition image (i.e., the foregoing first image sample), denoted as I_{cond}, and another object image sample is selected as a target generated image (i.e., the foregoing second image sample), denoted as I_{tgt}. Here, I_{cond} is obtained by individually matting out the object part through the mask image obtained in the early-stage data preparation process, i.e., the masked object image part in FIG. 8. The masked object image is transmitted to the pretrained Unet via the visual encoder. Similarly, the description text sample obtained in the preprocessing stage is processed by the text encoder to obtain the text embedding, which is also transmitted to the pretrained Unet.
3) An input of the subject feature preservation network is further obtained for the masked object image via a VAE model.
4) Meanwhile, I_{tgt} in the same object ID group is used as the input of the pretrained Unet to perform single-step noise addition (i.e., adding noise), and noise prediction is performed through the pretrained Unet to obtain predicted noise. A loss is then calculated. For example, an L2 loss may be calculated between a denoised result obtained by removing noise using a DDIM scheduler and the original input I_{tgt}, or between the predicted noise and the added noise. Then, weight vectors of the subject feature preservation network and the cross-attention part are iteratively optimized, where the cross-attention part is an additional part resulting from the extra visual encoder added in the pretrained Unet. The overall training logic is the same as the training logic of the diffusion model. The added noise is predicted through diffusion and sampling, and the model is iteratively optimized through loss comparison with the actually added noise. The training process actually involves randomly sampling a noisy image at step t, inputting the noisy image and step number t, with the model predicting noise ϵ. A training objective of the model is to minimize an error between the predicted noise and the actually added noise. Here, a single-step result of a diffusion network gradually denoising z(t–1) is z(t), and then z(t) becomes a new z(t–1) to continue single-step denoising to become the new z(t). In the training stage, this is a single-step iteration, while in the prediction stage (inference stage), the iteration step size may be 25-50 iterations.

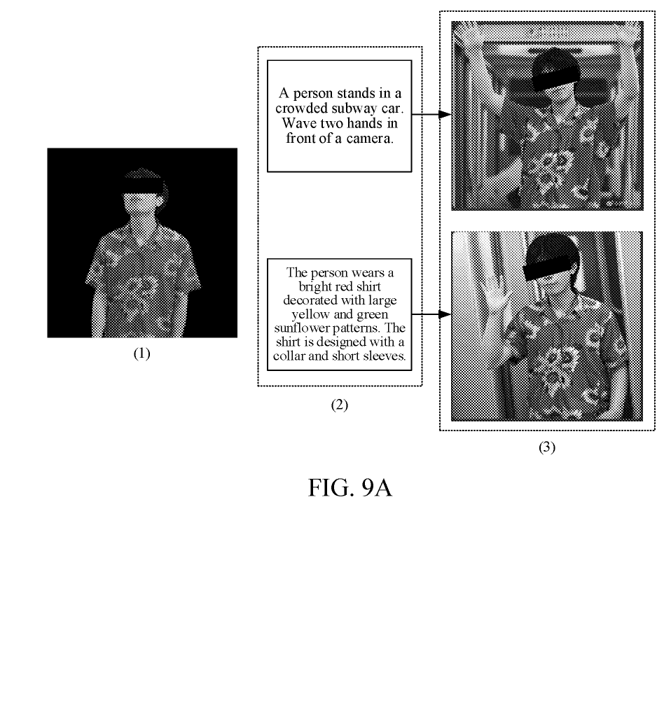

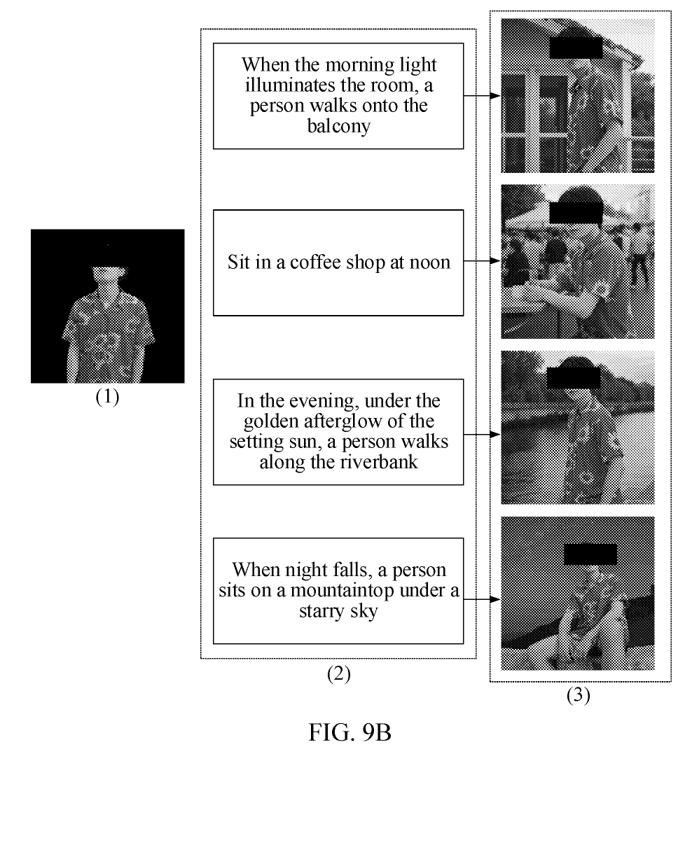

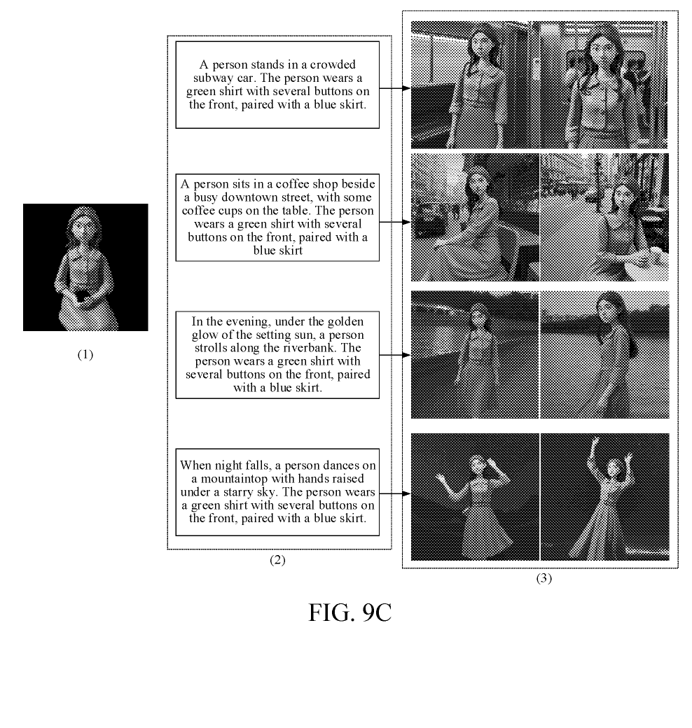

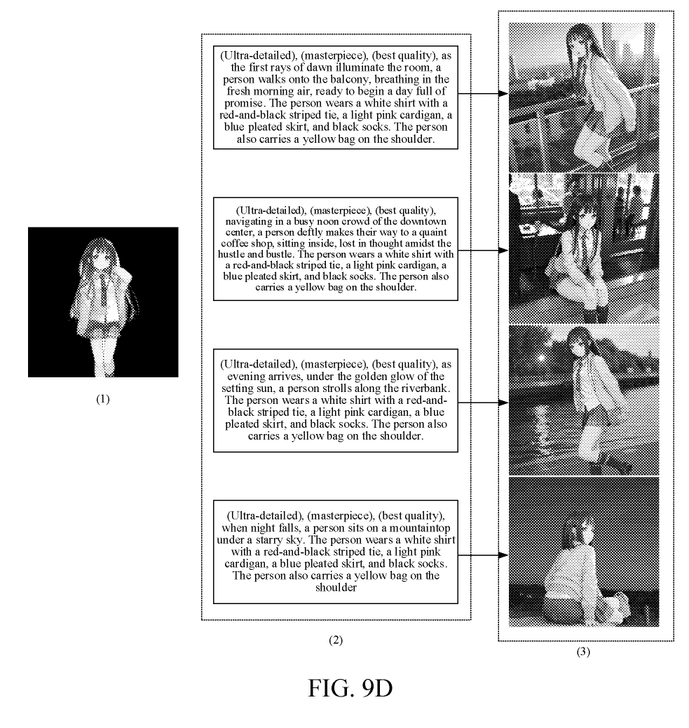

Application scenes of the image generation method provided in this embodiment of the present disclosure include the following aspects.
1) As shown in FIG. 9A, a human body image generation scene under a target human body ID is provided. As shown in FIG. 9A, a part (1) in FIG. 9A is an object image, a part (2) in FIG. 9A shows two types of image description text, and a part (3) in FIG. 9A shows target object images corresponding to the image description text.
2) As shown in FIG. 9B, a scene of generating multi-panel story comics under the same human body ID is provided. A part (1) in FIG. 9B is an object image, a part(2) in FIG. 9B shows four different types of image description text, and a part (3) in FIG. 9B shows target object images corresponding to the image description text, having different scenes and actions, while the patterns of the character's clothing are completely consistent.
3) As shown in FIG. 9C, a generation scene for four-panel comics or serialized comics of anime-style or 3D characters is provided. A part (1) in FIG. 9C is an object image, a part (2) in FIG. 9C shows four different types of image description text, and a part(3) in FIG. 9C shows target object images corresponding to the image description text, which are product illustrations of story comics or serialized story formats under different styles of human body IDs.
   As shown in FIG. 9D, a generation scene for four-panel comics or serialized comics of anime-style or 3D characters is provided.
      A part (1) in FIG. 9D is an object image,
      a part (2) in FIG. 9D shows four different types of image description text,
      and a part (3) in FIG. 9D shows target object images corresponding to the image description text, which are product illustrations of story comics or serialized story formats under different styles of human body IDs.
4) The human body ID is adopted to maintain subject consistency across multiple panels for story video production. Comic videos or serialized story videos with continuity are generated using the foregoing image results in combination with music and subtitle display.

In this embodiment of the present disclosure, the image generation model may maintain the object ID of any style without using a particular-style stable diffusion model, which benefits from the excellent characteristics of the subject feature preservation network proposed in the present disclosure. Certainly, this embodiment of the present disclosure may still be compatible with different styles of stable diffusion derivative models or low-rank adaptation (LoRA). For the controlnet, a corresponding controlnet model may be mounted on a trained image generation network to obtain input of an additional control signal, such as including depth maps, skeletal posture maps, and face deflection angle control for corresponding control over the generated results. The stable diffusion framework used in the present disclosure may be extended to the entire stable diffusion family, including but not limited to Stable Diffusion2.0 and Stable Diffusion XL.

According to the foregoing embodiments of the present disclosure, 1) in terms of input, both text features and object ID features are considered, and the two features may be mixed to realize dual control. 2) An object ID of any style may be maintained without using a particular-style stable diffusion model, and generated images obtained based on the embodiments of the present disclosure may strictly correspond to the object image in terms of the facial ID, character's clothing (especially, textures and patterns on the clothing), accessories, shoes, and hair style. 3) The embodiments of the present disclosure may further be combined with various stable diffusion derivative models, LoRA, adapter, and controlnet to realize more control (such as including depth maps, human skeletal posture maps, and face deflection angle control) based on ensuring the object ID.

The face in the accompanying drawings provided in the embodiments of the present disclosure is generated based on an artificial intelligence technology, rather than a real human face.

The following continues to describe an exemplary structure in which an image generation apparatus 555 provided in the embodiments of the present disclosure is implemented as software modules. In some embodiments, as shown in FIG. 2, the software modules in the image generation apparatus 555 stored in the memory 550 may include: an acquisition module 5551, configured to acquire preset noise, and acquire an initial object image and image description text of a preset object, the image description text describing a target attribute of the preset object; an encoding module 5552, configured to perform first encoding on the initial object image to obtain image encoding features, and perform second encoding on the image description text to obtain text encoding features; and a generation module 5553, configured to generate a target object image using a diffusion model based on the image encoding features, the text encoding features, and the preset noise, the target object image including the preset object corresponding to the target attribute.

In some embodiments, the generation module 5553 is further configured to extract object features of the preset object from the initial object image; and generate the target object image using the diffusion model based on the object features, the image encoding features, the text encoding features, and the preset noise.

In some embodiments, the object features include first object features and second object features. The generation module 5553 is further configured to perform third encoding on the initial object image to obtain object encoding features; downsample the initial object image based on the object encoding features to obtain the first object features; and upsample the first object features based on the object encoding features to obtain the second object features.

In some embodiments, the generation module 5553 is further configured to perform first convolution on the initial object image to obtain first convolution features; perform self-attention processing on the first convolution features to obtain a first processing result; and perform cross-attention processing on the object encoding features and the first processing result to obtain the first object features.

In some embodiments, the generation module 5553 is further configured to perform second convolution on the first object features to obtain second convolution features; perform self-attention processing on the second convolution features to obtain a second processing result; and perform cross-attention processing on the object encoding features and the second processing result to obtain the second object features.

In some embodiments, a downsampling process is implemented through M downsampling layers, and M is an integer greater than 1. The generation module 5553 is further configured to downsample the initial object image based on the object encoding features through a first downsampling layer of the M downsampling layers to obtain a layer downsampling result of the first downsampling layer; downsample a layer downsampling result of an (i–1)^{th} downsampling layer based on the object encoding features through an i^{th} downsampling layer of the M downsampling layers to obtain a layer downsampling result of the i^{th} downsampling layer; traverse i to obtain a layer downsampling result of an M^{th} downsampling layer, i being an integer greater than 1 and less than or equal to M; and use a layer downsampling result of each downsampling layer as the first object feature.

In some embodiments, an upsampling process is implemented through M upsampling layers, and an i^{th} upsampling layer of the M upsampling layers corresponds to the i^{th} downsampling layer. The generation module 5553 is further configured to upsample the first object features based on the object encoding features through an M^{th} upsampling layer of the M upsampling layers to obtain a layer upsampling result of the M^{th} upsampling layer; concatenate the layer downsampling result of the i^{th} downsampling layer and a layer upsampling result of an (i+1)^{th} upsampling layer to obtain a concatenation result of the i^{th} upsampling layer, and upsample the concatenation result of the i^{th} upsampling layer based on the object encoding features through the i^{th} upsampling layer to obtain a layer upsampling result of the i^{th} upsampling layer; traverse i to obtain a layer upsampling result of a first upsampling layer; and use a layer upsampling result of each upsampling layer as the second object feature.

In some embodiments, the generation module 5553 is further configured to perform the following processing using the diffusion model: denoising the preset noise based on the object features, the image encoding features, and the text encoding features to obtain denoising features; and performing image reconstruction on the denoising features to obtain the target object image.

In some embodiments, the generation module 5553 is further configured to downsample the preset noise based on the object features, the image encoding features, and the text encoding features to obtain a noise downsampling result; and upsample the noise downsampling result based on the object features, the image encoding features, and the text encoding features to obtain the denoising features.

In some embodiments, the generation module 5553 is further configured to perform first convolution on the preset noise to obtain first noise features; concatenate the first noise features and the object features to obtain a first concatenation result, and perform self-attention processing on the first concatenation result to obtain a third processing result; perform cross-attention processing on the image encoding features and the third processing result to obtain a first image processing result, and perform cross-attention processing on the text encoding features and the third processing result to obtain a first text processing result; and determine the noise downsampling result based on the first image processing result and the first text processing result.

In some embodiments, the generation module 5553 is further configured to perform second convolution on the noise downsampling result to obtain second noise features; concatenate the second noise features and the object features to obtain a second concatenation result, and perform self-attention processing on the second concatenation result to obtain a fourth processing result; perform cross-attention processing on the image encoding features and the fourth processing result to obtain a second image processing result, and perform cross-attention processing on the text encoding features and the fourth processing result to obtain a second text processing result; and determine the denoising features based on the second image processing result and the second text processing result.

In some embodiments, a denoising process includes T denoising, and T is an integer greater than 1. The generation module 5553 is further configured to perform first denoising on the preset noise based on the object features, the image encoding features, and the text encoding features to obtain intermediate denoising features outputted by the first denoising; perform, based on the object features, the image encoding features, and the text encoding features, t^{th} denoising on intermediate denoising features outputted by (t–1)^{th} denoising, to obtain intermediate denoising features outputted by the t^{th} denoising, t being an integer greater than 1 and less than or equal to T; and traverse t to obtain intermediate denoising features outputted by T^{th} denoising, and use the intermediate denoising features outputted by the T^{th} denoising as the denoising features.

In some embodiments, the image encoding features include the object features of the preset object.

In some embodiments, the generation module 5553 is further configured to acquire a required object image, the required object image representing a generation requirement of the preset object in the target object image; and extract required object features of the preset object in the required object image.

In some embodiments, the generation module 5553 is further configured to generate the target object image using the diffusion model based on the required object features, the image encoding features, the text encoding features, and the preset noise.

In some embodiments, the generation module 5553 is further configured to extract at least one of the following features of the required object image: depth map features of the required object image, object posture features of the preset object in the required object image, and object contour features of the preset object in the required object image.

In some embodiments, the acquisition module 5551 is further configured to acquire a candidate object image including the preset object; determine a target region in the candidate object image that is different from a region where the preset object is located; and cover the target region in the candidate object image to obtain the initial object image.

In some embodiments, an image generation process is implemented through an image generation model. The generation module 5553 is further configured to acquire a first image sample, a second image sample, and a description text sample, and add noise to the second image sample to obtain a noise image sample, the first image sample and the second image sample each including an object sample, the description text sample describing attributes of the object sample, and a region in the first image sample that is different from a region where the object sample is located being covered; extract first sample features of the object sample in the first image sample through an object feature extraction network of an initial image generation model; perform first encoding on the first image sample to obtain first encoding features, and perform second encoding on the description text sample to obtain second encoding features; perform image generation on the noise image sample through an image generation network of the initial image generation model based on the first sample features, the first encoding features, and the second encoding features to obtain a generated image; and train the initial image generation model based on a difference between the second image sample and the generated image to obtain the image generation model.

Descriptions of the apparatus embodiments in the present disclosure are similar to the descriptions of the foregoing method embodiments. The apparatus embodiments have similar beneficial effects as the method embodiments, and details are not described herein again. The technical details not exhaustively described in the image generation apparatus provided in the embodiments of the present disclosure may be understood based on the descriptions of the technical details in the foregoing method embodiments.

The embodiments of the present disclosure further provide a computer program product, including computer-executable instructions or a computer program, the computer-executable instructions or the computer program being stored in a computer-readable storage medium. A processor of an electronic device reads the computer-executable instructions or the computer program from the computer-readable storage medium and executes the computer-executable instructions or the computer program to cause the electronic device to perform the image generation method provided in the embodiments of the present disclosure.

The embodiments of the present disclosure further provide a computer-readable storage medium, having computer-executable instructions or a computer program stored therein, and the computer-executable instructions or the computer program, when executed by a processor, causing the processor to perform the image generation method provided in the embodiments of the present disclosure.

In some embodiments, the computer-readable storage medium may be a memory such as a RAM, a ROM, a flash memory, a magnetic surface memory, an optical disk, or a CD-ROM, or may be any device including one of or any combination of the foregoing memories.

In some embodiments, the computer-executable instruction may be written in the form of program, software, software module, script, or code in any form of programming language (including compilation or interpretation language, or declarative or procedural language), and may be deployed in any form, including being deployed as an independent program or being deployed as a module, assembly, subroutine, or another unit suitable for use in a computing environment.

As an example, the computer-executable instruction may but may not necessarily correspond to a file in a file system, may be stored in a part of the file for storing other programs or data, for example, stored in one or more scripts in a hyper text markup language (HTML) document, stored in a single file specially used for the discussed program, or stored in a plurality of collaborative files (for example, files storing one or more modules, a subprogram, or a code part).

As an example, the computer-executable instructions may be deployed to be executed on one electronic device, on a plurality of electronic devices located at one location, or on a plurality of electronic devices distributed at a plurality of locations and interconnected through a communication network.

In the embodiments of the present disclosure, relevant data such as user information is involved. When the embodiments of the present disclosure are applied to specific products or technologies, user permission or consent needs to be obtained, and the collection, use, and processing of relevant data need to comply with relevant laws, regulations, and standards of relevant regions.

The foregoing descriptions are merely embodiments of the present disclosure and are not intended to limit the protection scope of the present disclosure. Any modification, equivalent replacement, and improvement made within the spirit and scope of the present disclosure falls within the protection scope of the present disclosure.

What is claimed is:

1. An image generation method, applied to an electronic device, and comprising:
acquiring preset noise, and acquiring an initial object image and image description text of a preset object, the image description text describing a target attribute of the preset object;
performing first encoding on the initial object image to obtain image encoding features;
performing second encoding on the image description text to obtain text encoding features; and
generating a target object image using a diffusion model based on the image encoding features, the text encoding features, and the preset noise, the target object image comprising the preset object corresponding to the target attribute.

2. The method according to claim 1, wherein the generating a target object image using a diffusion model based on the image encoding features, the text encoding features, and the preset noise comprises:
extracting object features of the preset object from the initial object image; and
generating the target object image using the diffusion model based on the object features, the image encoding features, the text encoding features, and the preset noise.

3. The method according to claim 2, wherein the object features comprise first object features and second object features; and the extracting object features of the preset object from the initial object image comprises:
performing third encoding on the initial object image to obtain object encoding features;
downsampling the initial object image based on the object encoding features to obtain the first object features; and
upsampling the first object features based on the object encoding features to obtain the second object features.

4. The method according to claim 3, wherein the downsampling the initial object image based on the object encoding features to obtain the first object features comprises:
performing first convolution on the initial object image to obtain first convolution features;
performing self-attention processing on the first convolution features to obtain a first processing result; and
performing cross-attention processing on the object encoding features and the first processing result to obtain the first object features.

5. The method according to claim 3, wherein the upsampling the first object features based on the object encoding features to obtain the second object features comprises:
performing second convolution on the first object features to obtain second convolution features;
performing self-attention processing on the second convolution features to obtain a second processing result; and
performing cross-attention processing on the object encoding features and the second processing result to obtain the second object features.

6. The method according to claim 3, wherein a downsampling process is implemented through M downsampling layers, and M is an integer greater than 1; and the downsampling the initial object image based on the object encoding features to obtain the first object features comprises:
downsampling the initial object image based on the object encoding features through a first downsampling layer of the M downsampling layers to obtain a layer downsampling result of the first downsampling layer;
downsampling a layer downsampling result of an (i-1)^{th} downsampling layer based on the object encoding features through an i^{th} downsampling layer of the M downsampling layers to obtain a layer downsampling result of the i^{th} downsampling layer, i being an integer greater than 1 and less than or equal to M; and
using a layer downsampling result of each downsampling layer as the first object feature.

7. The method according to claim 6, wherein an upsampling process is implemented through M upsampling layers, and an i^{th} upsampling layer of the M upsampling layers corresponds to the i^{th} downsampling layer; and the upsampling the first object features based on the object encoding features to obtain the second object features comprises:
upsampling the first object features based on the object encoding features through an M^{th} upsampling layer of the M upsampling layers to obtain a layer upsampling result of the M^{th} upsampling layer;
concatenating the layer downsampling result of the i^{th} downsampling layer and a layer upsampling result of an (i+1)^{th} upsampling layer to obtain a concatenation result of the i^{th} upsampling layer, and upsampling the concatenation result of the i^{th} upsampling layer based on the object encoding features through the i^{th} upsampling layer to obtain a layer upsampling result of the i^{th} upsampling layer;
traversing i to obtain a layer upsampling result of a first upsampling layer; and
using a layer upsampling result of each upsampling layer as the second object feature.

8. The method according to claim 2, wherein the generating the target object image using the diffusion model based on the object features, the image encoding features, the text encoding features, and the preset noise comprises:
denoising the preset noise based on the object features, the image encoding features, and the text encoding features to obtain denoising features; and
performing image reconstruction on the denoising features to obtain the target object image.

9. The method according to claim 8, wherein the denoising the preset noise based on the object features, the image encoding features, and the text encoding features to obtain denoising features comprises:
downsampling the preset noise based on the object features, the image encoding features, and the text encoding features to obtain a noise downsampling result; and
upsampling the noise downsampling result based on the object features, the image encoding features, and the text encoding features to obtain the denoising features.

10. The method according to claim 9, wherein the downsampling the preset noise based on the object features, the image encoding features, and the text encoding features to obtain a noise downsampling result comprises:
performing first convolution on the preset noise to obtain first noise features;
concatenating the first noise features and the object features to obtain a first concatenation result, and performing self-attention processing on the first concatenation result to obtain a third processing result;
performing cross-attention processing on the image encoding features and the third processing result to obtain a first image processing result, and performing cross-attention processing on the text encoding features and the third processing result to obtain a first text processing result; and
determining the noise downsampling result based on the first image processing result and the first text processing result.

11. The method according to claim 9, wherein the upsampling the noise downsampling result based on the object features, the image encoding features, and the text encoding features to obtain the denoising features comprises:
performing second convolution on the noise downsampling result to obtain second noise features;
concatenating the second noise features and the object features to obtain a second concatenation result, and performing self-attention processing on the second concatenation result to obtain a fourth processing result;
performing cross-attention processing on the image encoding features and the fourth processing result to obtain a second image processing result, and performing cross-attention processing on the text encoding features and the fourth processing result to obtain a second text processing result; and
determining the denoising features based on the second image processing result and the second text processing result.

12. The method according to claim 8, wherein a denoising process comprises T denoising, and T is an integer greater than 1; and the denoising the preset noise based on the object features, the image encoding features, and the text encoding features to obtain denoising features comprises:
performing first denoising on the preset noise based on the object features, the image encoding features, and the text encoding features to obtain intermediate denoising features outputted by the first denoising;
performing, based on the object features, the image encoding features, and the text encoding features, t^{th} denoising on intermediate denoising features outputted by (t-1)^{th} denoising, to obtain intermediate denoising features outputted by the t^{th} denoising, t being an integer greater than 1 and less than or equal to T; and
traversing t to obtain intermediate denoising features outputted by T^{th} denoising, and using the intermediate denoising features outputted by the T^{th} denoising as the denoising features.

13. The method according to claim 1, wherein the image encoding features comprise the object features of the preset object.

14. The method according to claim 1, further comprising:
acquiring a required object image, the required object image representing a generation requirement of the preset object in the target object image; and
extracting required object features of the preset object in the required object image.

15. The method according to claim 14, wherein the generating a target object image using a diffusion model based on the image encoding features, the text encoding features, and the preset noise comprises:
generating the target object image using the diffusion model based on the required object features, the image encoding features, the text encoding features, and the preset noise.

16. The method according to claim 14, wherein the extracting required object features of the preset object in the required object image comprises:
extracting, from the required object image, at least one of: depth map features of the required object image, object posture features of the preset object in the required object image, or object contour features of the preset object in the required object image.

17. The method according to claim 1, wherein the initial object image is acquired by:
acquiring a candidate object image comprising the preset object;
determining a target region in the candidate object image that is different from a region where the preset object is located; and
covering the target region in the candidate object image to obtain the initial object image.

18. The method according to claim 1, wherein the diffusion model comprises an image generation model, and the method further comprises:
acquiring a first image sample, a second image sample, and a description text sample, and adding noise to the second image sample to obtain a noise image sample, the first image sample and the second image sample each comprising an object sample, the description text sample describing attributes of the object sample, and a region in the first image sample that is different from a region where the object sample is located being covered;
extracting first sample features of the object sample in the first image sample through an object feature extraction network of an initial image generation model;
performing first encoding on the first image sample to obtain first encoding features, and performing second encoding on the description text sample to obtain second encoding features;
performing image generation on the noise image sample through an image generation network of the initial image generation model based on the first sample features, the first encoding features, and the second encoding features to obtain a generated image; and
training the initial image generation model based on a difference between the second image sample and the generated image to obtain the image generation model.

19. An electronic device, comprising:
a memory, configured to store computer-executable instructions; and
a processor, configured, when executing the computer-executable instructions stored in the memory, to implement:
acquiring preset noise, and acquiring an initial object image and image description text of a preset object, the image description text describing a target attribute of the preset object;
performing first encoding on the initial object image to obtain image encoding features;
performing second encoding on the image description text to obtain text encoding features; and
generating a target object image using a diffusion model based on the image encoding features, the text encoding features, and the preset noise, the target object image comprising the preset object corresponding to the target attribute.

20. A non-transitory computer-readable storage medium, having computer-executable instructions or a computer program stored therein, and the computer-executable instructions or the computer program, when executed by a processor, causing the processor to implement:
acquiring preset noise, and acquiring an initial object image and image description text of a preset object, the image description text describing a target attribute of the preset object;
performing first encoding on the initial object image to obtain image encoding features;
performing second encoding on the image description text to obtain text encoding features; and
generating a target object image using a diffusion model based on the image encoding features, the text encoding features, and the preset noise, the target object image comprising the preset object corresponding to the target attribute.
